(19) United States
(12) Patent Application Publication
(10) Pub. No.: US 2024/0003505 A1
(43) Pub. Date: Jan. 4, 2024

(54) LED FILAMENT

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/036,919

(22) PCT Filed: Nov. 9, 2021
(86) PCT No.: PCT/EP2021/081010

§ 371 Date: May 15, 2023

(30) Foreign Application Priority Data
Nov. 16, 2020 (EP) 20207723.6

(51) Int. Cl. F21S 4/28; F21S 4/22

(52) U.S. Cl. CPC F21S 4/28; F21S 4/22; F21Y 2103/10

(57) ABSTRACT

A light emitting diode, LED, filament (100, 200, 420, 430, 510), comprising an array of a plurality of light emitting diodes (110, 250, 260, 270,410, 415), LEDs, wherein the LED filament comprises a center axis, A, and elongates in a meandering shape in a plane, P, is provided. At least a first segment (120, 220) of the LED filament, which elongates along the center axis, A, has first width, W₁, and is configured to emit light with a first intensity, I₁, and a first color temperature, CT₁. At least a second segment (130, 230) of the LED filament, which elongates along the center axis, A, has second width, W₂, and is configured to emit light with a second intensity, I₂, and a second color temperature, CT₂. For the at least one first segment and the at least one second segment, at least one of I₁≠I₂, CT₁≠CT₂, and W₁≠W₂ is fulfilled.

### FIELD OF THE INVENTION

The present invention generally relates to lighting arrangements comprising one or more light emitting diodes, LEDs. More specifically, the lighting arrangement is related to a light emitting diode, LED, filament. The present invention is further related to a lighting device comprising a LED filament.

### BACKGROUND OF THE INVENTION

The use of light emitting diodes, LEDs, for illumination purposes continues to attract attention. Compared to incandescent lamps, fluorescent lamps, neon tube lamps, etc., LEDs provide numerous advantages such as a longer operational life, a reduced power consumption, and an increased efficiency related to the ratio between light energy and heat energy.

There is currently a very large interest in lighting devices and/or arrangements (such as lamps) provided with LEDs, and incandescent lamps are rapidly being replaced by LED-based lighting solutions. It is nevertheless appreciated and desired to have retrofit lighting devices (e.g. lamps) which have the look of an incandescent bulb. For this purpose, it is possible to make use of the infrastructure for producing incandescent lamps based on LED filaments arranged in such a bulb. It will be appreciated that LED filament lamps of this kind are highly appreciated as they are very decorative.

However, it is of interest to improve one or more properties of the LED filaments. In particular, there is a wish to even further augment the aesthetical appearance and/or the decorative aspect of the LED filaments and/or the lighting arrangements comprising the LED filaments.

WO 2019/197394 discloses a LED filament lamp, comprising at least one filament extending over a length, L, along a longitudinal axis, A, wherein the LED filament comprises an array of a plurality of LEDs extending along the longitudinal axis, and an encapsulant at least partially enclosing the plurality of LEDs, wherein the encapsulant comprises a luminescent material, and wherein at least one of the thickness, TL, of the encapsulant along a transverse axis, B, perpendicular to the longitudinal axis, and the concentration, CL, of the luminescent material in the encapsulant, varies over at least a portion of the length, L, of the at least one filament along the longitudinal axis, whereby the color temperature, CTL, of the light emitted from the at least one LED filament varies over the length of the at least one LED filament at least along the portion thereof.

EP 3367757 discloses a lighting apparatus that comprises the following elements. A first set of light emitting diode module includes a variety of light emitting diode elements, wherein different types of light emitting diode elements have different color temperature characteristics. A driving circuit may supply currents with different total values, and the optical characteristics of the first set of light emitting diode module change accordingly, so as to change color temperatures.

### SUMMARY OF THE INVENTION

Hence, it is of interest to explore the possibility of even further augment the aesthetical appearance and/or the decorative aspect of the LED filaments and/or the lighting arrangements comprising the LED filaments.

This and other objects are achieved by providing a LED filament having the features in the independent claim. Preferred embodiments are defined in the dependent claims.

Hence, according to the present invention, there is provided a light emitting diode, LED, filament, comprising an array of a plurality of light emitting diodes, LEDs. The LED filament comprises a center axis and elongates in a meandering shape in a first plane. The LED filament comprises at least a first segment which elongates along the center axis, has a first width, W₁, and is configured to emit light with a first intensity, I₁, and a first color temperature, CT₁. Furthermore, the LED filament comprises at least a second segment which elongates along the center axis, has a second width, W₂, and is configured to emit light with a second intensity, I₂, and a second color temperature, CT₂. Moreover, at least one of I₁≠I₂, CT₁≠CT₂, and W₁≠W₂ is fulfilled.

Thus, the present invention is based on the idea of providing a flat meandering shaped LED filament which, for an observer, may be analogous in appearance to a spiral-shaped or coil-shaped LED filament. Hence, the purpose of the features of the LED filament of the present invention is to mimic the appearance of a LED filament having a spiral or coil shape. Moreover, the structure of the LED filament of the present aspect stems from the idea of optimizing the assembly process of LED filaments for lighting applications and provide a variability of lighting effects, ultimately reducing the cost for producing such LED filaments and improving its aesthetic appearance. An object of the present invention further resides in the use of the LED filament for luminaire applications which requires the use of filaments of minimal depth, i.e. as flat as possible, without compromising the lighting properties.

The present invention is advantageous in that the numerous advantages of using LED technology may be combined with the attractiveness and the appealing properties of the LED filament as disclosed.

The present invention is further advantageous in that the meandering shape of the LED filament contributes to the aesthetic attractiveness of the LED filament and/or the light emitted from the LED filament.

The present invention is further advantageous in that the LED filament of the present invention comprises relatively few components. The low number of components is advantageous in that the LED filament is relatively inexpensive to fabricate. Moreover, the low number of components of the LED filament implies an easier recycling, especially compared to devices or arrangements comprising a relatively high number of components which impede an easy disassembling and/or recycling operation.

The LED filament of the present invention comprises an array of a plurality of LEDs. By the term “array”, it is here meant a linear arrangement or chain of LEDs, or the like, arranged on the LED filament.

The LED filament comprises a center axis, A, and elongates in a meandering shape in a first plane, P. By “meandering shape”, it is here meant that the shape of the LED filament or the direction of unfoldment of the LED filament proceeds in a convoluted fashion. In other words, a meandering-shaped LED filament is a LED filament which pattern follows a sinusoidal shape. Furthermore, by the term “shape” it is here meant the physical property of the LED filament such as e.g. the size, form and/or configuration of the LED filament. By the term “plane”, it is here meant a flat surface. In other words, the LED filament embodies a sinusoidal pattern along the center axis, A, with substantially no deviation in a dimension perpendicular to the first plane, P. Therefore, the meandering shape of the LED filament encompasses only two dimensions, i.e. the ones forming the plane, P, which renders the LED filament very compact and thin.

The LED filament presents at least one first segment and at least one second segment as integral sections of the LED filament together elongating along the axis, A, in a meandering shape enabling said LED filament to be comprised in the first plane, P.

The first segment(s) and second segment(s) represent formative sections of the LED filament. Moreover, each of the first segment(s) and the second segment(s) have respective widths and are further configured to emit light according to a respective first intensity and second intensity and first color temperature and second color temperature. By the term “color temperature”, it is here meant the temperature of an ideal black-body radiator that radiates light of a color comparable to that of the LEDs. Hence, upon operation of the LED filament, the first segment(s) and second segment(s) of each LED filament are configured to distribute light with a respective first and second intensity and first and second color temperature of the light, wherein the first and second intensity, the first and second color temperature of the light and/or the widths differ between the first segment(s) and the second segment(s). For example, the light emitted from the first segment(s) during operation of the LED filament may have a relatively high intensity and color temperature, whereas the light emitted from the second segment(s) during operation of the LED filament may have a relatively low intensity and color temperature. The difference in intensity between the first segment(s) and the second segment(s) may be obtained by implementing a different LED pitch on the respective segments. In other words, a segment of a LED filament with a shorter LED pitch, i.e. spacing between individual LEDs of the plurality of LED, enables more LEDs to be mounted on a particular segment resulting in a greater light intensity. The intensity of the first segment (s) and second segment(s) may further be varied by the selection of different LED bins for the different segments. By the term “LED bins” it is here meant groups of LEDs sorted according to specific characteristics of the LEDs, e.g. color, required voltage, light intensity, etc. The difference in color temperature of LEDs and width between the first segment(s) and the second segment(s) may be obtained by using different LEDs or by selecting different encapsulants to at least partially enclose the LEDs, which will be detailed further in this application. Therefore, the capacity of the first segment(s) and second segment(s) of the LED filament to emit light with specific and individual lighting properties (i.e. light intensity and color temperature) enables a greater variety of lighting effects achievable by the LED filament when installed in a lamp or in a luminaire. Furthermore, the plurality of LEDs comprised on the first segment(s) and on the second segment(s) may allow an improved light distribution in contrast to LED filaments presented in the prior art. The difference in width between the first segment(s) and the second segment(s) also results in the obtaining of a greater variety of lighting effects achievable by the LED filament. It will be further appreciated that more than one of the properties of the first segment(s) of the LED filament may be similar to the respective properties of the second segment(s) of the LED filament. However, at least one of said properties, i.e. light intensity and/or color temperature and/or width, must differ between the first segment(s) and second segment(s) of the LED filament of the present invention to allow variety of lighting effects and to reach an aesthetic appeal resembling a spiral-shaped LED filament.

According to an embodiment of the present invention, at least one of 1.2 I₁<I₂ and (CT₁+300 K)<CT₂ is fulfilled.

According to an embodiment of the present invention, a single first segment of the at least one first segment may be followed by a single second segment of the at least one second segment along the center axis, A, in an alternating manner. The present embodiment is advantageous in that it enables the alternation of the light emission characteristics of the first and second segments along the elongation of the LED filament. In other words, a first segment comprising or providing a first light intensity, first color temperature and first width, is followed by a second segment comprising or providing a second light intensity, second color temperature and second width, wherein at least one of said parameters differs in an alternating manner. The present embodiment is further advantageous in that such alternation enables a greater distribution of the light effects of the different segments of the LED filament thus avoiding concentration of similar light characteristics or properties at specific positions along the elongation of the LED filament. The alternating manner with which the first segment(s) and second segment(s) follow one another further provides the possibility of a wider range of lighting effects achievable by the LED filament when installed in a lamp or in a luminaire.

According to an embodiment of the present invention, the at least one first segment and the at least one second segment may constitute linear portions of the LED filament which are connected by at least one curved portion of the LED filament. It will be appreciated that the linear portions forming the first segment(s) and second segment(s) may be substantially linear and that the curved portions connecting a first segment to a subsequent second segment may comprise a relatively short radius of curvature such that the curved portions may provide the appearance of rather sharp corners giving the sinusoidal shape or meandering shape to the LED filament. The present embodiment is advantageous in that the substantially linear portions improve the light distribution of the LEDs comprised thereon. Moreover, the curved portion(s) provide a transition portion between the differently characterized first segment(s) and second segment(s) of the LED filament. Additionally, the aesthetical appearance of the LED filament arrangement is increased.

According to an embodiment of the present invention, the at least one curved portion may have a third width, W₃, and is configured to emit light with a third intensity, I₃, and a third color temperature, CT₃, wherein at least one of I₁<I₃<I₂, CT₁<CT₃<CT₂, and W₁<W₃<W₂ is fulfilled. Hence, at least one of I₃, CT₃ and W₃ of the curved portion(s) may be defined or bound by the characteristics of the first and second segments. For example, one or more of I₃, CT₃ and W₃ may be constant. Alternatively, there may be a gradual decrease of the intensity and/or the color temperature and/or the width of the curved portions of the LED filament structure along the center axis, A, in one direction. Consequently, in the opposite direction along the center axis, A, there may be an increase of the intensity and/or the color temperature and/or the width of the curved portions of the LED filament structure. The present embodiment is advantageous in that the curved portion(s) provide(s) a transition between the substantially linear portions forming the first segment(s) and the second segment(s), resulting in an even more improved lighting effect. Furthermore, the present embodiment is advantageous in that a gradual increase or decrease of the properties of the different portions of the LED filament provides an illusion of depth or perspective to the LED filament therefore enabling an aesthetic appearance closely resembling a spiral-shaped LED filament.

According to an embodiment of the present invention, at least one of the at least one first segment and the at least one second segment may comprise an encapsulant at least partially enclosing the at least one of the at least one first segment and the at least one second segment. By the term “encapsulant”, it is here meant a material, element, arrangement, or the like, which is configured or arranged to at least partially surround, encapsulate and/or enclose the plurality of LEDs of the LED filament(s). The encapsulant may comprise at least one of a luminescent material configured to at least partly convert light emitted from the plurality of LEDs and a light scattering material configured to scatter light emitted from the plurality of LEDs. This is advantageous in that the LED filament may provide a desired light distribution and/or a decorative effect.

According to an embodiment of the present invention, the at least one first segment may comprise the encapsulant, wherein the encapsulant may have a first thickness, T_{L1}, and a first concentration, Cu, of a luminescent material in the encapsulant. According to the same embodiment of the present invention, the at least one second segment may comprise the encapsulant, wherein the encapsulant may have a second thickness, T_{L2}, and a second concentration, C_{L2}, of a luminescent material in the encapsulant wherein at least one of T_{L1} T_{L2} and C_{L1}≠C_{L2} is fulfilled. By the term “luminescent material”, it is here meant a material, composition and/or substance which is configured to emit light under external energy excitation. For example, the luminescent material may comprise a fluorescent material. The luminescent material is configured to convert at least a portion or part of the light emitted from the plurality of LEDs into converted light. The present embodiment is advantageous in that the variation in thicknesses and/or in concentration of the encapsulant in turn enables the variation of the color temperature, CT, of the first segment(s), second segment(s) and the curved portion(s). Hence, the present embodiment provides a variation in the light distribution of the various portions of the LED filament along its sinusoidal elongation resulting in improved lighting effect and providing an aesthetic appearance closely resembling a spiral-shaped LED filament.

According to an embodiment of the present invention, a number of LEDs, dN₁, per unit length, dL₁, of the at least one first segment, dN₁/dL₁, and a number of LEDs, dN₂, per unit length, dL₂, of the at least one second segment, dN₂/dL₂, fulfill dN₁/dL₁≠dN₂/dL₂. In other words, the ratio of number of LEDs to length of segment of the LED filament (i.e. the concentration of LEDs along a segment length) differs from at least one first segment to at least one second segment. The present embodiment is therefore advantageous in that it enables a greater variety of lighting effects through differently LED-loaded first segment(s) and second segment(s). For example, by having a different number of LEDs per unit of length, the first segment(s) and the second segment(s) of the LED filament(s) distribute light differently therefore providing a different illuminative effect.

According to an embodiment of the present invention, the at least one first segment may comprise a first set of LEDs of the plurality of LEDs, wherein the first set of LEDs is arranged to emit light with a first LED intensity, I_{L1}, and the at least one second segment may comprise a second set of LEDs of the plurality of LEDs, wherein the second set of LEDs is arranged to emit light with a second LED intensity, I_{L2}, wherein I_{L1}≠I_{L2}. The present embodiment is advantageous in that it enables a greater variety of lighting effects through different intensity of light for the first segment(s) and second segment(s). For example, having different intensities of LEDs on the first segment(s) and the second segment(s), enables a variable light emission between at the least one first segment and the at least one second segment along the meandering-shaped LED filament.

According to an embodiment of the present invention, the at least one first segment may comprise M LEDs and the at least one second segment may comprise N LEDs, wherein 2M<N. The present embodiment is advantageous in that the at least one first segment, having a relatively small number of LEDs, to an even higher extent may be designed to direct light in a specific spatial direction towards an object such as a table, a painting, etc., whereas the light from the at least second segment, having a relatively large number of LEDs, may be directed in another direction or other directions. Consequently, the present embodiment is advantageous in that it provides a variety of lighting effects of the LED filament.

According to an embodiment of the present invention, the LED filament may comprise a carrier arranged to support the plurality of LEDs. It will be appreciated that the carrier may be formed of a light transmissive material, such that it facilitates the transmission or distribution of the light emitted by the LEDs. It will be further embodied that the carrier may be formed of rigid materials e.g. glass, ceramic, sapphire, or formed of flexible materials e.g. polymer such as polyamide, etc. Moreover, the carrier may comprise electrodes for electrically connecting the at least one LED of the plurality of LEDs. The present embodiment is advantageous in that at least a portion of the light from the LEDs of the LED filament(s) may be transmitted through the carrier, thereby further contributing to the lighting properties and/or decorative appearance of the LED filament arrangement.

According to an embodiment of the present invention, there is provided a lighting device. The lighting device may comprise a LED filament arrangement according to any one of the preceding embodiments, and a cover comprising an at least partially light-transmissive material, wherein the cover at least partially encloses the LED filament arrangement. The lighting device may further comprise an electrical connection connected to the LED filament arrangement for a supply of power to the plurality of LEDs of the LED filament arrangement. For example, the electrical connection may be done through a mechanical connection used for holding the LED filament in place in the lighting device or may be a heat sink on which the LED filament is applied, e.g. glue, resulting in a better thermal management within the lighting device. It will be appreciated that the lighting deice may be a lamp comprising a lamp cap or a luminaire comprising a power plug.

According to an embodiment of the present invention, the cover of the lighting device may constitute a light output window arranged in a second plane, S, parallel to the first plane, P. Furthermore, the light output window may be configured to diffuse the light emitted from the plurality of LEDs. It will be appreciated that the meandering shape of the LED filament elongating along the center axis faces the light output window given the parallel relation of the first plane, P, and the second plane, S. The present embodiment is therefore advantageous in that the light output window improves the distribution of the light emitted by the various portions of the LED filament facing it. The present embodiment is further advantageous in that the light diffusing window provides protection to the LED filament resulting in greater longevity of the light device, e.g. luminaire, in which the LED filament is used.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 shows a LED filament lamp according to the prior art,

FIG. 2 shows a LED filament according to an exemplifying embodiment of the present invention,

FIGS. 3a-3b shows a section of the LED filaments according to exemplifying embodiments of the present invention,

FIGS. 4a-4b shows a cross section of a first segment and a second segment of the LED filament according to exemplifying embodiments of the present invention, and

FIG. 5 shows a lighting device according to exemplifying embodiments of the present invention.

### DETAILED DESCRIPTION

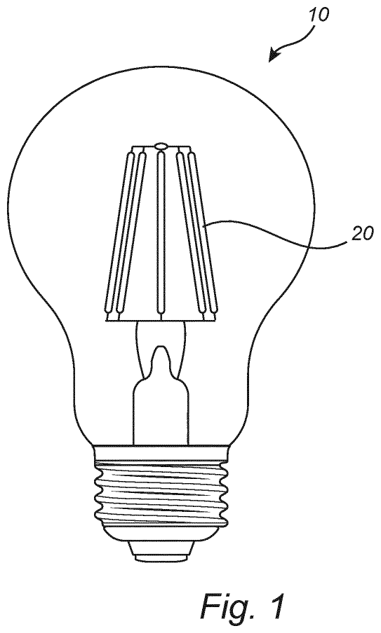

FIG. 1 shows a LED filament lamp 10 according to the prior art, comprising a plurality of LED filaments 20. LED filament lamps 10 of this kind are highly appreciated as they are very decorative, as well as providing numerous advantages compared to incandescent lamps such as a longer operational life, a reduced power consumption, and an increased efficiency related to the ratio between light energy and heat energy. LED filament lamps 10 of this kind are able to produce warm white light. However, it is of interest to improve the properties of the light emitted from the LED filaments 20 without impairing the appearance and/or the decorative aspect of the LED filaments 20 and/or the LED filament lamps 10.

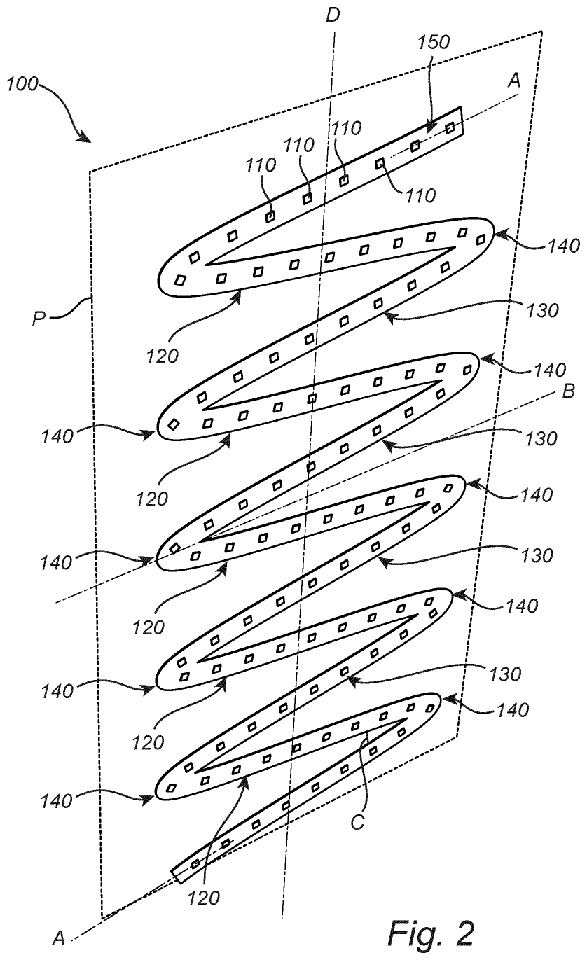

FIG. 2 shows a LED filament 100 according to an exemplifying embodiment of the present invention. The LED filament 100 is shown having a meandering shape or sinusoidal shape resembling a coil-shaped LED filament. The meandering-shaped LED filament 100 of FIG. 2 is shown elongating along a center axis, A, within a first plane, P, wherein the first plane, P, is a flat plane formed or spanned by a first axis, D, and a second axis, B, perpendicular to the first axis, D. The flat first plane, P, thus enables the LED filament 100 to be highly suitable for luminaire applications, which require flatter light sources, whilst still having the aesthetic appearance of a spiral or coil-shaped LED filament.

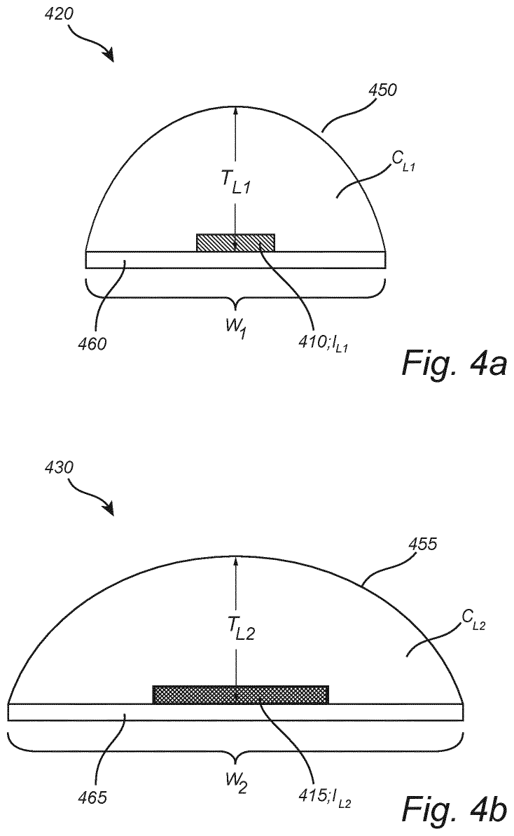

FIG. 2 further illustrates an array of a plurality of LEDs 110 mounted on a sinusoidal-shaped carrier 150 which in turn is a flat carrier 150 (detailed later in FIGS. 4a-4b) comprised in the first plane, P. The LED filament 100 is shown in FIG. 2 comprising the array of a plurality of LEDs 110 disposed along the meandering-shaped LED filament 100 configured to emit light to create a lighting effect resembling a coil-shaped LED filament. The LED filament 100 is shown separated into first segments 120 followed by second segments 130 in an alternating manner along center axis, A. The first segments 120 and the second segments 130 are shown as substantially linear portions of the LED filament 100 connected to one another by curved portions 140. The curved portions 140 are shown in FIG. 2 having a relatively small radius of curvature, C, therefore forming rather sharp corners enabling repetitive transitions between the first segments 120 and the second segments 130 of the LED filament 100. The curved portions or sharp corners 140 provide in FIG. 2 the optical illusion of a depth or perspective to the flat LED filament 100, which mimics a spiral-shaped or coil-shaped LED filament.

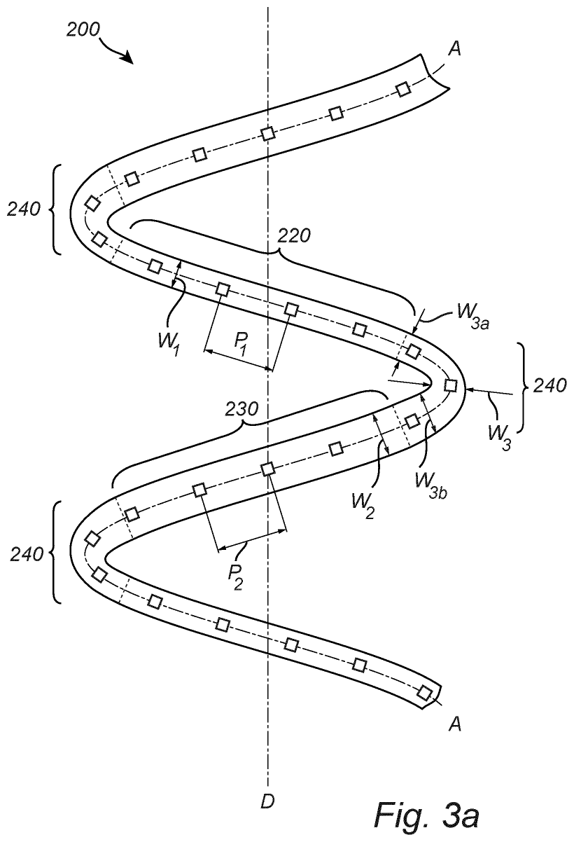

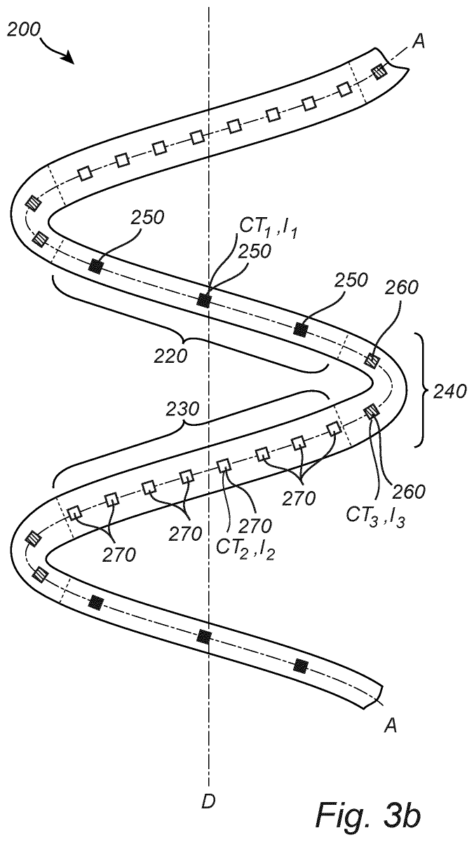

FIG. 3a illustrates a section of a LED filament 200 according to an exemplifying embodiment of the present invention. The section of the LED filament 200 is shown elongating in a meandering shape along the center axis, A, and comprising a first segment 220 and a second segment 230 substantially linear and connected to one another by the curved portion 240. The substantially linear first segments 220 and second segments 230 should preferably be of a length of 1 cm, more preferably of a length of 2 cm and most preferably of a length of 3 cm. FIG. 3a further shows the first segment 220 having a width, W₁, constant throughout said first segment 220 and shows the second segment 230 having a second width, W₂, constant throughout the second segment 230. FIG. 3a further shows the width of the first segment, W₁, being smaller than (inferior to) the width of the second segment, W₂, such that an illusion of depth or perspective is generated by the LED filament 200. It is to be noted that the width, W₁, of the first segment 220 and the width, W₂, of the second segment 230 are respectively similar for each alternating first segments 220 and second segments 230 of the LED filament 200 along its elongation. It will be appreciated that the width, W₁, of the first segment 220 and the width, W₂, of the second segment 230 may preferably fulfil W₁<1.2 W₂ and most preferably fulfil W₁<1.5 W₂. The ratio of the widths, W₁, W₂, between the first and second segment(s) 220, 230 enables the LED filament 200 to mimic the appearance of a spiral LED filament. FIG. 3a further illustrates curved portion 240 having a width, W₃, such that the width, W₁, of the first segment 220 is inferior to the width, W₃, of the curved portion 240 which in turn is inferior to the width, W₂, of the second segment 230. Furthermore, FIG. 3a shows the width, W₃, of the curved portion 240 increasing as a function of the elongation of the LED filament 200 along the center axis, A. FIG. 3a illustrates the gradually varying width of the curved portion, W₃, having a first width, W₃ₐ, at the end of the curved portion 240 connected to the first segment 220 and a second width, W_{3b}, at the end of the curved portion 240 connected to the second segment 230, wherein the first width, W₃ₐ, is inferior to the second width, W_{3b}. In other words, the width, W₃, of a curved portion 240 of the LED filament 200 increases gradually when a first segment 220 transitions to a second segment 230 and decreases gradually when a second segment 230 transitions to a first segment 220. FIG. 3a further illustrates a variation of pitch or spacing between the plurality of LEDs comprised in the first segment 220 and the plurality of LEDs comprised on the second segment 230. In other words, a first pitch, P₁ (or first concentration) between the LEDs comprised on the first segment 220 differs from a second pitch, P₂ (or second concentration) between the LEDs comprised on the second segment 230. The difference in pitch shown in FIG. 3a therefore indicates that the number of LEDs per unit of length of the first segment 220 differs from the number of LEDs per unit of length of the second segment 230, i.e. dN₁/dL₁≠dN₂/dL₂ wherein dN₁ and dL₁ represent the number of LEDs and the length of the first segment 220 and dN₂ and dL₂ represent the number of LEDs and the length of the second segment 230. It will be appreciated that preferably 1.2 dN₁/dL₁<dN₂/dL₂ is fulfilled and that more preferably 1.5 dN₁/dL₁<dN₂/dL₂ is fulfilled. The ratio of density of LEDs per unit of length between the first and second segment(s) enables the LED filament to mimic the difference in light emission observed in a spiral LED filament between the light emitted in a direction facing the LEDs of the spiral structure, which usually represents 65% to 90% of the light emitted, and the light emitted in a direction facing away from the LEDs of the spiral structure.

FIG. 3b illustrates the section of a LED filament 200 as shown in FIG. 3a according to an exemplifying embodiment of the present invention. Similarly to FIG. 3a, FIG. 3b shows a LED filament 200 having a first segment 220 and a second segment 230 connected by a curved portion 240. The LED filament 200 comprises an array of a plurality of LEDs arranged differently according to the different portions of the LED filament 200. The first segment 220 is shown in FIG. 3b having 3 LEDs 250 disposed on its substantially linear portion wherein the LEDs 250 are characterized by a first color temperature, CT₁, and by a first light emission intensity, I₁. FIG. 3b further illustrates the second segment 230 having 7 LEDs 270 disposed on its substantially linear portion wherein the LEDs 270 are characterized by a second color temperature, CT₂, and by a first light emission intensity, I₂.

It will be appreciated that the first color temperature, CT₁, and the second color temperature, CT₂, preferably fulfil (CT₁+300K)<CT₂ and most preferably fulfil (CT₁+500K)<CT₂. The ratio of color temperatures between the first and second segment(s) 220, 230 enables the LED filament 200 to mimic the difference in color temperature observed in a spiral LED filament between the light emitted in an outward direction, i.e. direction facing the LEDs of the spiral structure, and the light emitted in an inward direction, i.e. the direction facing away from the LEDs of the spiral structure. Having the first color temperature, CT₁, of the first segment 220 being lower than the second color temperature, CT₂, of the second segment 230 therefore enables the LED filament 220 to resemble the variation in color temperature observed between the outside of the spiral LED filament and the inside of a spiral LED filament. Similarly, it will be appreciated that the first intensity, I₁, and the second intensity, I₂, preferably fulfil 1.2 I₁<I₂ and most preferably fulfil 1.5 I₁<I₂. The ratio of intensities between the first and second segment(s) 220, 230 enables the LED filament 220 to mimic the difference in intensities observed in a spiral LED filament between the light emitted in a direction facing the LEDs of the spiral structure, which usually represents 65% to 90% of the light emitted, and the light emitted in a direction facing away from the LEDs of the spiral structure. Additionally, it will be appreciated that preferably I₁<I₂ and CT₁<CT₂ are fulfilled, such as 1.2 I₁<I₂ and (CT₁+300K)<CT₂. It may be more preferable that I₁<I₂, CT₁<CT₂, and W₁<W₂ are fulfilled, such as 1.2 I₁<I₂, (CT₁+300K)<CT₂ and 1.2 W₁<W₂.

The number of LEDs disposed on each portion may vary but fulfil 2M<N wherein M represents the number of LEDs 250 disposed on the substantially linear portion of the first segment 220 and N represents the number of LEDs 270 disposed on the substantially linear portion of the second segment 230. The color temperature of the LEDs 250, 260 and 270 differ preferably at least 300K, more preferably at least 500K and most preferably 700K. Furthermore, the color temperature, CT₁, of the LEDs 250 of the first segment 220 differs from the color temperature, CT₂, of the LEDs 270 of the second segment 230 and differs from the color temperature, CT₃, of the LEDs 260 of the curved portion 240. Preferably, the variation in color temperature between the different portions is inferior to 2000K, more preferably inferior to 1500K and most preferably inferior to 1200K. For example, the color temperature, CT₁, of the LEDs 250 is inferior to 2500K, more preferably inferior to 2300K and most preferably inferior to 2200K whereas the color temperature CT₂ of the LEDs 270 is preferably superior to 2700K, more preferably superior to 2900K and most preferably superior to 3000K. Additionally, the curved portion 240 of the LED filament 200 is shown having 2 LEDs 260 being characterized by a third color temperature, CT₃, and by a first light emission intensity, I₃. It is therefore embodied that the LED filament 200 shown in FIG. 3a and FIG. 3b fulfil at least one of I₁<I₃<I₂, CT₁<CT₃<CT₂, and W₁<W₃<W₂. It will be appreciated that preferably at least one of 1.2 I₁<I₃<I₂, 1.2 CT₁<CT₃<CT₂, and 1.2 W₁<W₃<W₂ may be fulfilled, and more preferably at least one of 1.5 I₁<I₃<I₂, 1.5 CT₁<CT₃<CT₂, and 1.5 W₁<W₃<W₂ may be fulfilled.

FIG. 4a illustrate a cross section of the first segment 420 of the LED filament according to the previous figures. The cross section of the first segment 420 illustrates a LED 410 of the plurality of LEDs mounted and supported in the center of a carrier 460 and arranged to emit light with a first LED intensity, I_{L1}. It is to be noted that the LED 410 may also be mounted off-centered on the carrier 460. The carrier 460 shown in FIG. 4a comprises a flat structure of minimal thickness and may be formed of a rigid or flexible material. The carrier 460 is shown defining the width, W₁, of the first segment 420 of the LED filament. FIG. 4a further illustrates an encapsulant 450 mounted on the carrier 460 and enclosing the LED 410 arranged on the first segment 420 of the LED filament. It is to be noted that the encapsulant 450 acts as a filling material surrounding the LED filament and is formed of a luminescent material having a first concentration, C_{L1}. The encapsulant 450 of the first segment is further shown having a semi-circular cross section and comprising a first thickness, T_{L1}, substantially equivalent to half the width, W₁, at its highest point, i.e. when measured perpendicularly from the carrier 460.

FIG. 4b illustrates a cross section of the second segment 430 of the LED filament according to the previous figures. The cross section of the second segment 430 illustrates a LED 415 of the plurality of LEDs mounted and supported in the center of a carrier 465 and arranged to emit light with a second LED intensity, I_{L2}. It is to be noted that the LED 415 may also be mounted off-centered on the carrier 465. The carrier 465 shown in FIG. 4b comprises a flat structure of minimal thickness and may be formed of a rigid or flexible material. The carrier 465 is shown defining the width, W₂, of the second segment 430 of the LED filament. FIG. 4b further illustrates an encapsulant 455 mounted on the carrier 465 and enclosing the LED 415 arranged on the second segment 430 of the LED filament. Similarly to FIG. 4a, the encapsulant 455 acts as a filling material surrounding the LED filament and is formed of a luminescent material having a second concentration, C_{L2}. The encapsulant 455 of the second segment 430 is further shown having a semi-circular cross section and comprising a second thickness, T_{L2}, substantially equivalent to half the width, W₂, at its highest point, i.e. when measured perpendicularly from the carrier 465. The carrier 460 of FIG. 4a and the carrier 465 of FIG. 4b may be formed of different materials. For example, the carrier 460 of the first segment 420 may be formed of a rigid material and the carrier 465 of the second segment 430 may be formed of a flexible material or vice versa. Furthermore, the dimensions of the LEDs 410, 415 may vary between the first segment 420 and second segment 430 as depicted by the LED 410 shown having smaller dimensions in FIG. 4a compared to the LED 415 illustrated in FIG. 4b. It will further be appreciated that the first thickness, T_{L1}, of the encapsulant 450 shown in FIG. 4a differs from the second thickness, T_{L2}, of the encapsulant 455 of the second segment shown in FIG. 4b such that various lighting effect may be achieved from each segment along the LED filament. Moreover, the luminescent material forming the encapsulant 450 of the first segment illustrated in FIG. 4a differs from the luminescent material forming the encapsulant 455 of the second segment illustrated in FIG. 4b with regards to their respective concentrations, C_{L1}, C_{L2}. For example, the luminescent material of the encapsulant 450 may comprise a yellow phosphor and a red phosphor whilst the encapsulant 455 may comprise a yellow phosphor and a deep red phosphor providing a different lighting effect for the first segment and the second segment. It will therefore be embodied that the cross section of the first segment 420 shown in FIG. 4a and the cross section of the second segment shown in FIG. 4b may fulfil at least one of T_{L1}≠T_{L2}, C_{L1}≠C_{L2} and I_{L1}≠I_{L2}, more preferably at least one of 1.2 T_{L1}<T_{L2} and 1.2 C_{L1}<C_{L2} and most preferably at least one of 1.5 T_{L1}<T_{L2} and 1.5 C_{L1}<C_{L2}. It will further be appreciated that preferably 1.2 I_{L1}<I_{L2} is fulfilled and that more preferably 1.5 I_{L1}<I_{L2} is fulfilled.

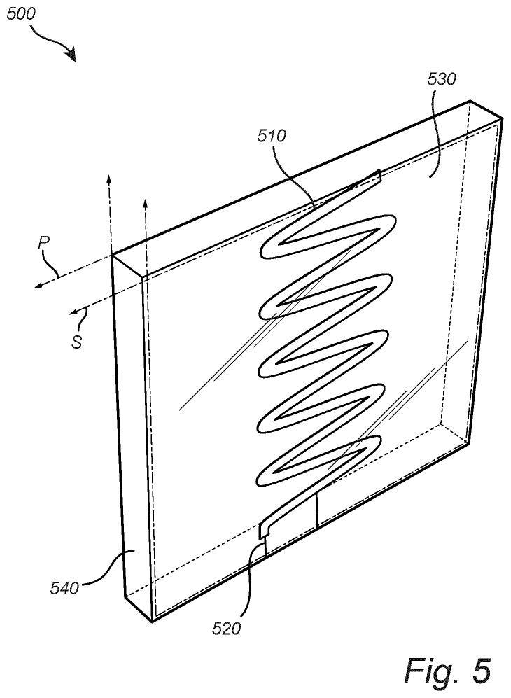

FIG. 5 illustrates a lighting device 500, e.g. a luminaire, comprising a LED filament 510 according to any embodiment of the previous figure(s) and associated text(s). FIG. 5 further shows the LED filament 510 mounted on a frame 540 such that the LED filament 510 elongates in a meandering shape in the first plane, P. Moreover, the lighting device 500 is shown comprising an electrical connection 520 connected to the LED filament 510 for supplying power to the plurality of LEDs of the LED filament 510. The lighting device 500 of FIG. 5 further comprises a cover or light output window 530, formed of a material at least partially light transmissive, mounted on the frame 540 and over the LED filament 510 such that the light output window 530 diffuses the light emitted from the plurality of LEDs of the LED filament 510. FIG. 5 further depicts the light output window 530 comprised in a second plane, S, which in turn is shown parallel to the first plane, P, of the LED filament 510.

The person skilled in the art realizes that the present invention by no means is limited to the preferred embodiments described above. On the contrary, many modifications and variations are possible within the scope of the appended claims. For example, one or more of the LED filament(s) 100, the first segment 120 and/or the second segment 130 etc., may have different shapes (sinus shape, zigzag shape, etc.), dimensions and/or sizes than those depicted/described.

1. A light emitting diode, LED, filament, comprising
an array of a plurality of light emitting diodes, LEDs, wherein the LED filament comprises a center axis, A, and elongates in a meandering shape in a first plane, P, wherein
at least a first segment of the LED filament, which elongates along the center axis, A, has a first width, W₁, and is configured to emit light with a first intensity, I₁, and a first color temperature, CT₁, and
at least a second segment of the LED filament, which elongates along the center axis, A, has second width, W₂, and is configured to emit light with a second intensity, I₂, and a second color temperature, CT₂,
wherein at least one of I₁≠I₂, CT₁≠CT₂, and W₁≠W₂ is fulfilled,
wherein a single first segment of the at least one first segment is followed by a single second segment of the at least one second segment along the center axis, A, in an alternating manner, and
wherein the at least one first segment and the at least one second segment constitute linear portions of the LED filament which are connected by at least one curved portion of the LED filament,
wherein the curved portion has a third width W₃ such that W₁<W₃<W₂ is fulfilled, and the third width, W₃, of the curved portion increases gradually when the first segment transitions to the second segment and decreases gradually when the second segment transitions to the first segment.

2. The LED filament according to claim 1, wherein at least one of 1.2 I₁<I₂ and (CT₁+300 K)<CT₂ is fulfilled.

3. The LED filament according to claim 1, wherein the at least one curved portion has a third width, W₃, and is configured to emit light with a third intensity, I₃, and a third color temperature, CT₃, wherein at least one of I₁<I₃<I₂, CT₁<CT₃<CT₂, and W₁<W₃<W₂ is fulfilled.

4. The LED filament according to claim 3, wherein at least one of I₃, CT₃ and W₃ is configured to change as a function of length along the center axis, A.

5. The LED filament according to claim 1, wherein at least one of the at least one first segment and the at least one second segment comprises an encapsulant, at least partially enclosing the at least one of the at least one first segment and the at least one second segment.

6. The LED filament according to claim 5, wherein
the at least one first segment comprises the encapsulant, and wherein the encapsulant has a first thickness, T_{L1}, and a first concentration, C_{L1}, of a luminescent material in the encapsulant, and
the at least one second segment comprises the encapsulant, and wherein the encapsulant has a second thickness, T_{L2}, and a second concentration, C_{L2}, of a luminescent material in the encapsulant,
wherein at least one of T_{L1}≠T_{L2} and C_{L1}≠C_{L2} is fulfilled.

7. The LED filament according to claim 1, wherein
a number of LEDs, dN₁, per unit length, dL₁, of the at least one first segment, dN₁/dL₁, and
a number of LEDs, dN₂, per unit length, dL₂, of the at least one second segment, dN₂/dL₂, fulfill dN₁/dL₁≠dN₂/dL₂.

8. The LED filament according to claim 1, wherein
the at least one first segment comprises a first set of LEDs of the plurality of LEDs, wherein the first set of LEDs is arranged to emit light with a first LED intensity, I_{L1}, and
the at least one second segment comprises a second set of LEDs of the plurality of LEDs, wherein the second set of LEDs is arranged to emit light with a second LED intensity, I_{L2}, wherein I_{L1}≠I_{L2}.

9. The LED filament according to claim 1, wherein the at least one first segment comprises M LEDs and the at least one second segment comprises N LEDs, wherein 2M<N.

10. The LED filament according to claim 1, further comprising a carrier arranged to support the plurality of LEDs.

11. A lighting device, comprising
a LED filament according to claim 1,
a cover comprising an at least partially light-transmissive material, wherein the cover at least partially encloses the LED filament, and
an electrical connection connected to the LED filament for a supply of power to the plurality of LEDs of the LED filament.

12. The lighting device according to claim 11, wherein the cover constitutes a light output window arranged in a second plane, S, parallel to the first plane, P.

13. The lighting device according to claim 12, wherein the light output window is configured to diffuse the light emitted from the plurality of LEDs.
